(19) United States
(12) Patent Application Publication
(10) Pub. No.: US 2026/0135702 A1
(43) Pub. Date: May 14, 2026

(54) FILE FORMAT-BASED TRANSPARENT ENCRYPTION

(71) Applicants: Lemon Inc., Grand Cayman (KY); Beijing Zitiao Network Technology Co., Ltd., Beijing (CN)

(72) Inventors: Zhongyan QIU, Culver City, CA (US); Zhi DONG, Culver City, CA (US); Shaoxiong ZHOU, Beijing (CN); Yumin CHEN, Culver City, CA (US); Wanyi ZHANG, Culver City, CA (US); Xiaonan MENG, Beijing (CN)

(21) Appl. No.: 19/016,829

(22) Filed: Jan. 10, 2025

Related U.S. Application Data
(63) Continuation of application No. PCT/CN2024/131361, filed on Nov. 11, 2024.

(51) Int. Cl. H04L 9/08

(52) U.S. Cl. CPC H04L 9/088

(57) ABSTRACT

This specification relates to file format-based transparent encryption tailored for big data. In some aspects, a method includes receiving a write request including a table with one or more columns to be stored in a storage device; compressing table data in a unit of block, wherein each column includes a number of blocks; generating a column key for each column and a block key for each block including sensitive information; encrypting (i) each block including sensitive information with a corresponding block key and (ii) rest of blocks in each column with a corresponding column key; generating wrapped keys for the column keys and block keys and storing the wrapped keys into a key file; and storing the encrypted blocks of each column into a data file in a data folder of the storage device.

### CROSS-REFERENCE TO RELATED APPLICATION

This application claims priority to PCT International Application No. PCT/CN2024/131361 filed Nov. 11, 2024, the disclosure of which is incorporated herein by reference in its entirety.

### TECHNICAL FIELD

This specification generally relates to security and privacy of big data.

### BACKGROUND

Big data technologies are widely used across various fields. These technologies handle data that is large and complex. Clickhouse is a columnar storage file format optimized for use with big data processing frameworks. While big data technologies are widely used, they also raise security concerns. A traditional big data encryption solution, such as the original Clickhouse encryption codec, is a client-side encryption, which requires the client to explicitly set the encryption configurations. This involves specifying encryption and decryption methods and keys when inserting or querying data. However, not every client has the required security background to handle these tasks effectively. Such traditional solutions are not transparent to the end users and cannot automate key isolation. Additionally, the traditional Clickhouse disk encryption solution requires the administrator to specify the encryption method and key used in configuration files, which is generally not flexible or scalable.

Traditional solutions further fail to support key isolation, key access control, or key rotation, and thus are less secure. Additionally, the encryption granularity of the traditional solutions is usually the entire table or folder, which limits on-demand decryption, and hurts the database query efficiency. Moreover, in traditional solutions of big data application scenarios, the file system, which is in the storage layer, is usually separated from the database computation layer, so that the operations in the storage layer do not have knowledge of the data schema and cannot achieve fine-grained access control.

### SUMMARY

This document describes technologies related to file format-based transparent encryption tailored for big data. These technologies take into account the specific file formats within a user's big data ecosystem and encrypt data at the smallest unit level of these formats. Data keys for encryption are generated on the server-side to provide seamless transparency. The computing system on the server-side centrally manages these data keys and other keys involved in the encryption process. A schema-based permission model is employed for precise access control, requiring different user privileges to access data with different security levels. Envelope encryption is used to make the solution scalable and maintainable, particularly for large enterprises. Encrypted data and data keys are stored separately, with the encrypted data linked to a reference of the data key information. This ensures that encrypted data files can be copied or moved across different environments without losing the ability to access or decrypt them.

The technologies described in this document provide file format-based transparent encryption on big data that is tailored to fit the specific file formats of a user's big data ecosystem. The technologies centralize key management to offer seamless transparency to end users and simplify both the writing and reading process of big data. Specifically, the server-side computing system generates data keys used to encrypt the big data, eliminating the need for users to have a security background. In the encryption process, fine-grained encryption of the smallest data units within the file formats is performed, which allows precise access control and offers various encryption modes for flexibility.

Furthermore, the technologies implement stringent access control through schema-based permissions, ensuring robust data security by protecting encryption keys and preventing unauthorized users from accessing restricted data.

Additionally, the described technologies store the encrypted data and the data keys separately, linking the encrypted data with a reference to the data key information. This allows data files containing encrypted data to be copied or moved across different environments while maintaining the ability to access and decrypt them.

In one aspect, this document describes a method for file format-based transparent encryption on big data. The method includes receiving, by one or more computing devices, a write request including a table with one or more columns to be stored in a storage device; compressing table data in a unit of block, wherein each column includes a number of blocks; generating a column key for each column and a block key for each block including sensitive information; encrypting (i) each block including sensitive information with a corresponding block key and (ii) rest of blocks in each column with a corresponding column key; generating wrapped keys for the column keys and block keys and storing the wrapped keys into a key file; storing the encrypted blocks of each column into a data file in a data folder of the storage device and storing the wrapped keys in a key file in a separate key file folder; and storing a reference to the key file in a header of each encrypted block in the data file.

Other embodiments of this aspect include corresponding computer systems, apparatus, computer program products, and computer programs recorded on one or more computer storage devices, each configured to perform the actions of the method. A system of one or more computers can be configured to perform particular operations or actions by virtue of having software, firmware, hardware, or a combination of them installed on the system that in operation causes or caused the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations, the key file can be in a dedicated space in a shared file system that requires permission to access.

In some implementations, each wrapped key can include an identifier of a data key and location information of data that is encrypted using the data key. In some implementations, a wrapped key can be signed using a wrapped key signing key.

In some implementations, the reference can indicate a storage location of the key file.

In some implementations, each data key, included in the column keys and the block keys, can be encrypted using a master key. The master key can be encrypted using a root key.

In some implementations, the method can include receiving, from a data reader, a read request for retrieving a block from the table; obtaining, from the data file, an encrypted block corresponding to the requested block; obtaining a storage location of the key file from the header of the encrypted block in the data file; identifying, in the key file, the wrapped key corresponding to the requested block; obtaining a data key used to encrypt the requested block by unwrapping the wrapped key; using the data key to decrypt the encrypted block to obtain the requested block in plaintext; and returning the requested block to the data reader.

In some implementations, the table can be divided into columns and sensitive rows. Separate column privileges can be required to read each column except the sensitive rows and separate row privileges are required to read each sensitive row. A permission model to access table data can include four hierarchies: “table privilege,” “table+row privilege,” “column privilege,” and “column+row privilege.”

In some implementations, the method can include recording table level metadata; recoding column level metadata; encrypting the table level metadata with a table key; encrypting the column level metadata with the column key; storing the encrypted table level metadata into a second data file; storing the encrypted column metadata into a third data file; generating a wrapped key for the table key; storing the wrapped key for the table key into another key file in the key file folder; storing, in a header of second data file, a reference to the another key file including the wrapped key for the table key; and storing, in a header of the third data file, a reference to the key file including the wrapped key for the column key.

In some implementations, the table level metadata can include table indexes. The column level metadata can include (i) position information of each compressed block and (ii) position information of a first row of each granule included in a decompressed block. Each granule can include a predetermined number of rows of the table.

In some implementations, encrypting each block can further include: expanding the block to include a plurality of hidden columns, wherein the number of hidden columns corresponding to the number of sensitive row ranges for each original column of the block; and encrypting each column and hidden column with a respective column key.

Particular implementations of the subject matter described in this specification can be implemented so as to realize one or more of the following advantages. The technologies described in this document provide file format-based transparent encryption on big data. The described technologies enable encryption of the smallest data unit within the file format and offer various encryption modes for flexibility. The described technologies fit the empirical model for the user's particular big data ecosystem by considering the file formats of the ecosystem. By enabling encryption of the smallest data unit, encryption in fine granularity is achieved, which allows for precise access control and the ability to perform cryptographic shredding.

Further, the described technologies centralize key management for easy access to achieve seamless transparency for end users. By providing end-to-end transparency to the end users, the technologies do not require end users to have security background, and thus simplify the writing and reading process for the end users while ensuring the security of the data.

Furthermore, the described technologies store the encrypted data and the data keys separately, while attaching a reference to the data key information to the encrypted data. As a result, the data files including the encrypted data can be copied or moved across different environments without losing the ability to access or decrypt them.

The described technologies also provide stringent access control through a schema-based permission to ensure robust data security. The technologies protect the encryption key and close the gap for malicious users to read data that they do not have permission to.

It is appreciated that methods and systems in accordance with the present description can include various combinations of the aspects and features described herein. That is, methods and systems in accordance with the present description are not limited to the specific combinations of aspects and features specifically described here, but also may include other combinations of the aspects and features provided.

The details of one or more implementations of the present description are set forth in the accompanying drawings and the description below. Other features and advantages of the present description will be apparent from the description and drawings, and from the claims.

### BRIEF DESCRIPTION OF DRAWINGS

FIG. 1 is an example environment for file-format based transparent encryption on big data.

FIG. 2 is a flow diagram of an example process for writing table data in file-format based transparent encryption.

FIG. 3 is an example of a table with a particular format.

FIG. 4A is a block diagram showing an example of granules in the table.

FIG. 4B is a block diagram showing an example of table level metadata.

FIG. 5 is a block diagram showing an example of column level metadata.

FIG. 6A is a table example with sensitive rows in a schema-based permission model.

FIG. 6B is another table example with sensitive rows.

FIG. 6C is an example table illustrating hidden columns.

FIG. 7 is a block diagram showing an example of fine-grained encryption in the table.

FIG. 8 is an example of a wrapped key.

FIG. 9 is a block diagram of an example envelope encryption model incorporating a three-layer key hierarchy.

FIG. 10 is an example of data files generated in response to the writing request.

FIG. 11 is a block diagram of an example process of secret management.

FIG. 12 is a block diagram of an example process of root key rotation.

FIG. 13 is a flow diagram of an example process for reading table data in file-format based transparent encryption.

FIG. 14 illustrates block diagrams of example computing devices.

FIG. 15 illustrates an example empirical model.

FIG. 16 is a diagram illustrating a nested file structure.

### DETAILED DESCRIPTION

This specification describes technologies for file-format based transparent encryption on big data. The technologies consider the specific file formats of a user's big data ecosystem and encrypt the data in the smallest data unit of the file formats. The technologies generate the data keys used to encrypt the data on the server side to offer seamless transparency. The technologies centrally manage the data keys and other keys generated in the encryption process. The technologies employ schema-based permission models for precise access control, where a user needs different privileges to read data of different security levels. The technologies also employ envelope encryption to provide scalability. The described technologies store the encrypted data and the data keys separately, linking the encrypted data with a reference to the data key information. So that the data files containing encrypted data can be copied or moved across different environments while maintaining the ability to access and decrypt them.

In some implementations, the data ecosystem can include a data warehouse such as Clickhouse, a column-oriented database management system for online analytical processing that supports queries and analysis of big data stored in a distributed manner. The data ecosystem may include different components or services with different levels of trust. One empirical model for big data processing systems defines three layers with different levels of trust ability. At a top layer for fully trustable services, secure services such as key management are managed with stringent security conditions including access control. At a middle, semi-trustable, layer various data computation can occur including by data readers and data writers. Data readers and writers may be developed by different parties that may not incorporate security procedures to ensure trust. Furthermore, a third un-trustable layer may include other services such as third party storage services, e.g., cloud storage services. Secrets, e.g., keys, are placed in the trusted services while all information sent from services that are not trusted, or semi-trusted, need to be verified.

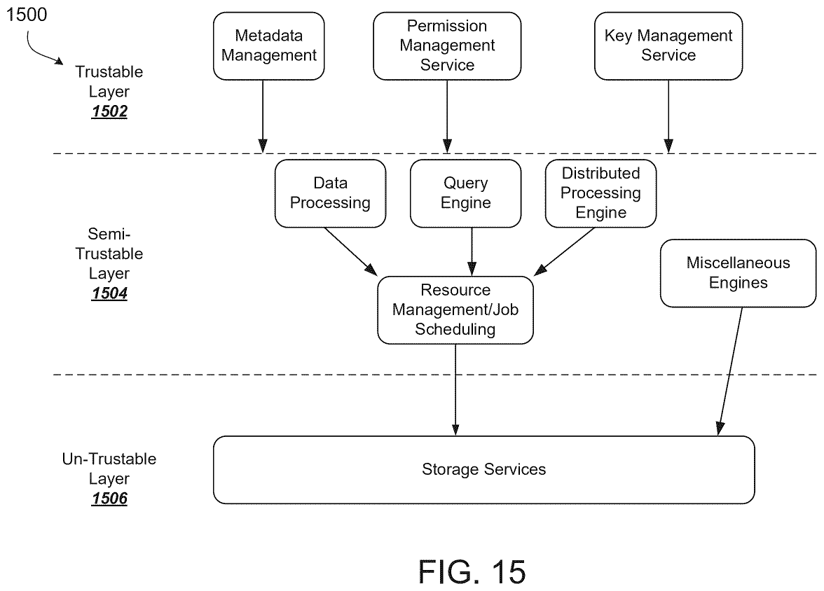

FIG. 15 shows an example of the empirical model 1500. As illustrated in FIG. 15, the empirical model 1500 includes trustable layer 1502, semi-trustable layer 1504, and un-trustable layer 1506. The trustable layer 1502 includes, for example, metadata management, permission management, and key management services. The semi-trustable layer 1504 includes services for data computation such as data processing services, query engines, distributed processing engines, and resource management and job scheduling services. The un-trusted layer 1506 includes storage services.

This three layer empirical model is informed by a set of three observable facts and two assumptions. The facts include: 1) limited data writing mediums, 2) numerous data reading mediums, and 3) decoupled storage and database layers. With respect to the limited data writing mediums, typically, a restricted number of mediums are permitted to write data files such as Clickhouse UI. With respect to the numerous data reading mediums, a wide range of tools can be used to read data files from SQL interfaces, programmatic options, and direct access methods. The open-source nature of data file formats exacerbates this by enabling the creation of custom reading tools. Finally, with respect to decoupled storage and database layers, the storage layer is typically separated from the database layer and lacks awareness of the data schema, leading to inconsistency in access control. Storage can also be decentralized, further complicating the control mechanisms.

The two assumptions are that 1) data writers intend to secure data at rest, operating under the belief that leaking data would not be beneficial to them and 2) Conversely, data readers may seek to extend their access scope, which is what security solutions seek to guard against. The following description of file formation-based transparent encryption is designed to adapt to the above empirical model with the three facts and two assumptions to provide a technological solution that provides a framework driven by six core concepts, described in detail below: granular encryption, modular key usage, trust anchoring and access control, scalable envelope encryption, and transparent encryption configuration. In the solution, all the secrets and sensitive configurations are stored, and their access is managed in the trustable layer services. All the information that is persisted in the un-trustable layer has been protected by encryption or signature which cannot be tampered with, and all of the logic and information that has been given to or running on the semi-trustable layer has been minimized and managed separately in Data Writers and Data Readers, which fits the assumptions.

The conventional Clickhouse framework lacks a mature encryption solution. This specification describes technologies that modify the Clickhouse framework to provide a modular encryption solution. For example, to provide granular encryption, a nested file structure is created. Additionally, to allow Clickhouse to support modular keys usage, a federated column writer/reader is provided in order to provide granularity finer than a column level. The nested file structure and federated column writer/reader are described in greater detail below.

The nested file structure includes a table header file. The table header file includes important encryption meta information including an encryption flag that identifies a table as encrypted or not and table encryption metadata that stores encryption algorithms and key references used with respect to a corresponding wrapped key. The nested file structure also includes table level metadata files that are encrypted using table level data keys. The nested file structure also includes column header files. The column header file contains column encryption metadata and is encrypted using the table level data keys. The nested file structure includes column level metadata files and column level data files, both of which are encrypted using column data keys.

When writing data under the nested file structure framework, a data writer needs to encrypt compressed blocks and column level metadata files, encrypt column encryption metadata using table level data key, and encrypt table level metadata files using the table level data key. When reading data, a data reader needs to read the encryption flag in the table header file to determine if the table is encrypted or not. If encrypted, the file level data key is accessed using the table encryption metadata, the table level metadata files are decrypted with the file level data key, the column encryption metadata are decrypted using the file level encryption key to access column data keys using the column encryption metadata, and the column metadata files and data files are decrypted.

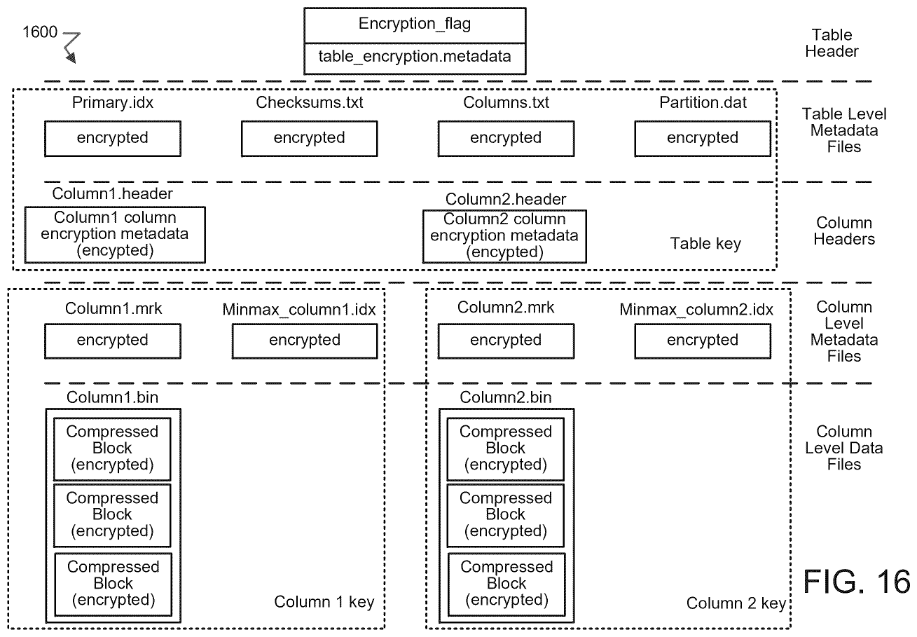

Thus, the nested file structure allows for modular key usage to provide fine-grained encryption for each table. FIG. 16 is a diagram 1600 illustrating a nested file structure. Specifically, FIG. 16 illustrates the different layers for a two column table represented in a nested file structure from the table header to the column level data files as well as the respective table encryptions, column 1 encryptions, and column 2 encryptions.

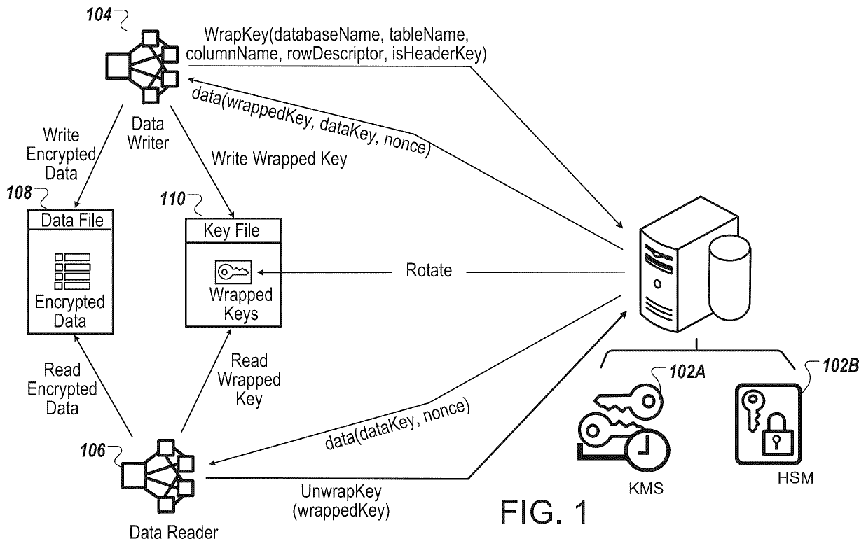

FIG. 1 is an example environment for file-format based transparent encryption on big data. The example environment 100 includes a number of components within a distributed system. The environment 100 includes one or more data writers 104 and one or more data readers 106. The environment 100 also includes one or more trusted computing devices that provide key management services including a key management system (KMS) 102A and a hardware security module (HSM) 102B. The components are communicatively coupled over a network (not shown). The network can include a local area network (“LAN”), a wide area network (“WAN”), the Internet, or a combination thereof.

In some instances, the specification refers to the services having a lower trust level, e.g., the data writers and data readers, as being on a “client side” of the environment and the trusted services, e.g., the KMS and HSM, as corresponding to a “server side” of the environment.

The data writers 104 and data readers 106 can be any suitable Internet-connected user device, e.g., a laptop or desktop computer, a smartphone, or an electronic tablet. The user device can be connected to the Internet through a mobile network, through an Internet service provider (ISP), or otherwise. Each user device is configured with software, which will be referred to as a client or as client software, that in operation can access the components of the environment 100.

Each data writer 104, in response to obtaining table data that is to be written into a storage device, obtains one or more data keys used to encrypt the table data. The data keys will be stored in the KMS 102A. The data writer calls the KMS 102A to generate keys and provides data location information for the table data being stored, including, for example, database, table, column, and row descriptor. The KMS 102A returns one or more data keys to the data writer 104. The KMS 102A further wraps the identifiers (IDs) of the data keys and the corresponding data location information in a wrapped key. The KMS 102A returns the wrapped key to the data writer 104, which stores the wrapped key in separate key file 110. The wrapped key is a data model that ensures authenticity of the information passed from the data readers. The wrapped key can take the form of a JSON web token where the payload holds a claim of what the data keys are and where the data come from (e.g., the data location information). The KMS 102A signs the token with a private key, which can be referred to as a wrapped key signing key.

The data writer 104 uses the generated data key(s) to encrypt the table data. The encrypted data are written into data files 108 in a data folder of the storage device. After encryption, the data writer 104 does not retain the data key(s).

In some embodiments, the table data are in a column-oriented table. The table includes one or more columns, each column includes a number of blocks. The environment 100 enables granular encryption of the smallest data units within the file formats. Additionally, this granular encryption uses modular keys, described below, to provide access control. Different keys are used for different kinds of data. Table keys are used for cross-column or table level metadata files. Column keys are used for different columns, e.g., for column-level metadata files. Block keys are used for rows that contain sensitive data and use the same keys for other rows. To do this, the federated column writer/reader is employed (detailed below). For example, the data writer 104 encrypts the table data in fine granularity by encrypting sensitive blocks with block keys. Sensitive blocks are blocks having one or more cells that contain sensitive data. Furthermore, each column has a separate column key that is a data key used to encrypt the data included in that column. By using the same column key for the same column, the overhead of KMS interaction is minimized.

Each data reader 106, in response to a read request for retrieving a block from the table, retrieves the encrypted data from the corresponding storage device. The data reader 106 then calls the KMS 102A to request the data key for the encrypted data. Specifically, the data reader 106 reads a wrapped key associated with the encrypted data from key file 110 and provides the wrapped key with the data key request to the KMS 102A The KMS 102A unwraps the wrapped key to obtain the data key that is used to encrypt the requested block and provides the data key to the data reader 106. After obtaining the data key, the data reader 106 can use the data key to decrypt the encrypted requested block. After decrypting, the data reader 106 returns the requested block in plaintext to the requestor. Thus, the trusted KMS 102A controls access to the data keys by unwrapping the keys at the time of data access. The unwrapped information, e.g., the data location information, is used by the KMS 102A for access authorization, which ensures data can only be decrypted and read by users with appropriate permissions. Thus, the wrapping process provides a trust anchoring that allows the KMS to trust the data location information and other metadata passed by the data writers or data readers to the KMS.

The environment 100 employs a schema-based permission model for precise access control. A user needs separate column privileges to read each column except the sensitive rows, and separate row privileges to read each sensitive row.

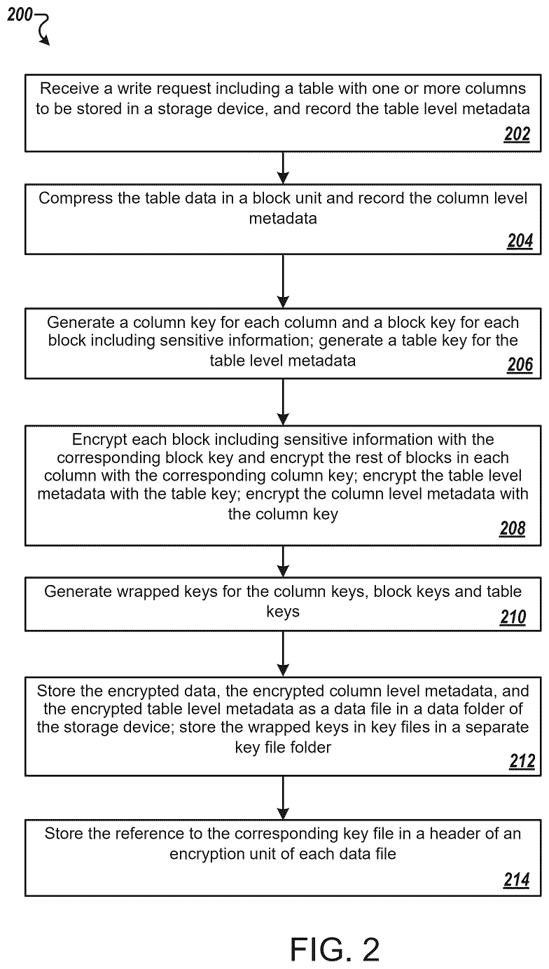

The environment 100 also employs envelope encryption to make the solution scalable. In the envelope encryption, each data key is encrypted using a master key, each master key is encrypted using a root key. One master key can be used to encrypt m data key. The data keys and the master keys are managed by the KMS 102A. The encrypted data keys are stored in KMS 102A. The master keys are encrypted by root keys which are securely stored and managed within the HSM 102B, ensuring the root keys never leave the secure environment. The HSM's sole responsibility is to protect the integrity of the root keys. One root key will be used to encrypt n master keys. FIGS. 2-13 and associated descriptions provide additional details of these implementations.

The environment 100 can include one or more computing devices, such as one or more servers or multiple distributed computing devices. In some implementations, the number of computing devices may be scaled (e.g., increased or decreased) automatically as per the computation resources needed. In some implementations, the environment 100 can implement cloud-based resources where the number of virtual machines commissioned depend on the required computational resource. The various functional components of the environment 100 may be instantiated in one or more computers as separate functional components or as different modules of the same functional component. For example, the various components of the environment 100 can be implemented as computer programs installed on one or more computers in one or more locations that are coupled to each through a network. In cloud-based systems, for example, these components can be implemented by individual computing nodes of a distributed computing system.

FIG. 2 is a flow diagram of an example process for writing table data in file-format based transparent encryption. For convenience, the process 200 will be described as being performed by a system of one or more computers, located in one or more locations, and programmed appropriately in accordance with this specification. For example, a computing system, e.g., encompassing the component of the environment 100 including to data writer 104 of FIG. 1, appropriately programmed, can perform the process 200.

At step 202, the computing system receives a write request including a table with one or more columns to be stored in a storage device. The computing system records the table level metadata in a first metadata file. The table level metadata includes the index of the table.

The computing system receives the write request from the data writer. The write request includes the necessary data location information, such as database name, table name, column name, row descriptor, etc. The file format of the table indicates that the table is column oriented. The table in Clickhouse includes one or more columns, each column includes a number of granules. The table is sorted according to the primary key. The primary key includes the fields of one or more columns.

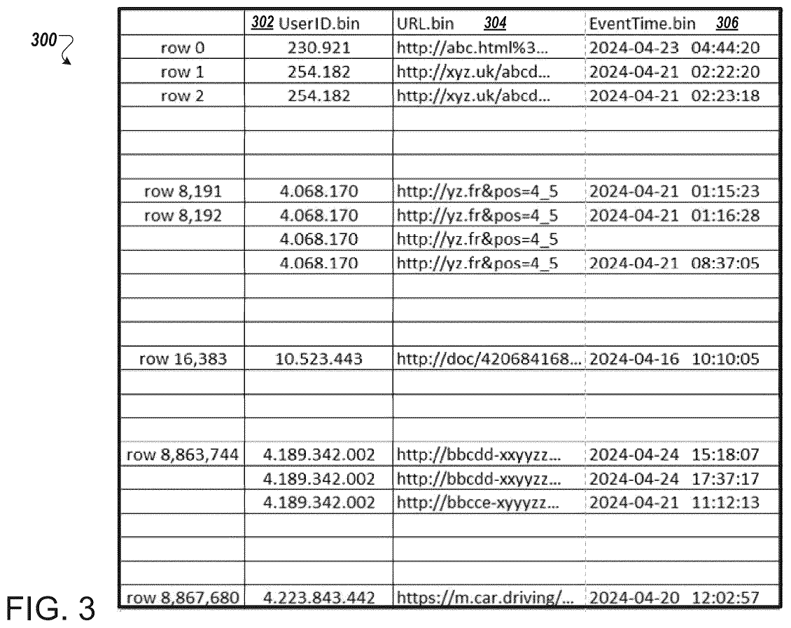

FIG. 3 is a table example 300 with the particular format in Clickhouse. In the example shown in FIG. 3, the table includes three columns, UserID 302, URL 304, and EventTime 306. The primary keys in this example table are UserID and URL corresponding to the first column and the second column. In other words, the table data are sorted by UserID and URL.

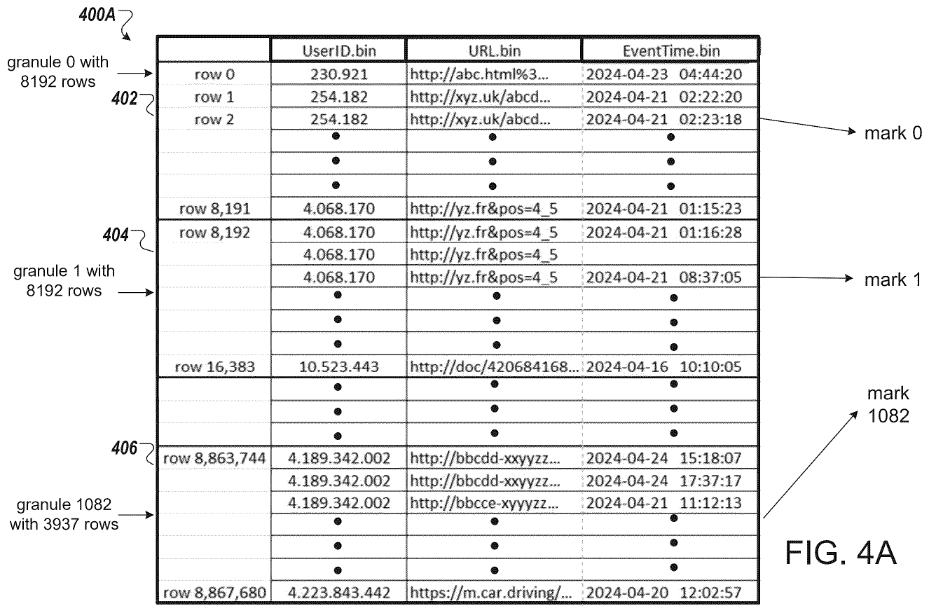

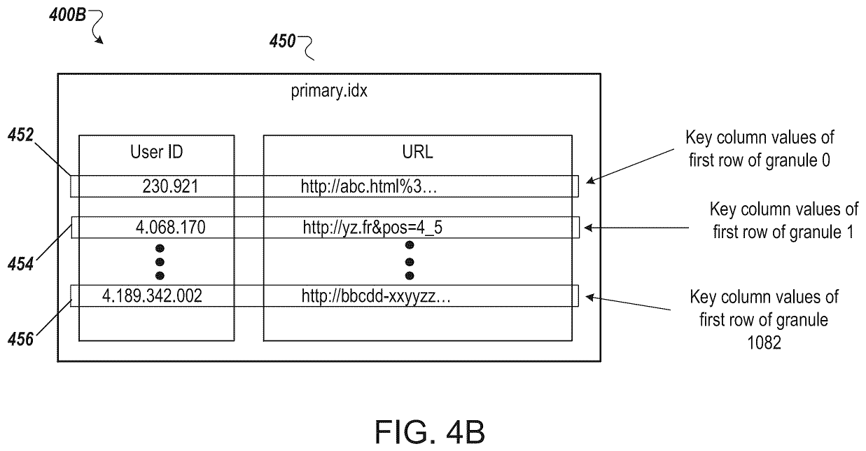

The table data are divided into several small groups, with each group including a predetermined number of rows. Each group is called a granule. The users can specify the number of rows included in each granule. FIG. 4A is a block diagram showing an example of granules in the table 400. In this example, each granule includes 8192 rows. Specifically, the first granule (granule_0) 402 includes row_0 to row_8,191. The second granule (granule_1) 404 includes row_8,192 to row_16,383. This continues in a similar manner until the last granule. The last granule (granule_1082) 406 includes the rest of the rows in the table, for example, the last 3937 rows of the table. The last granule (granule_1082) 406 includes row_8,863,744 to row_8,867,680.

The table level metadata includes the index of the table. The index of the table is established according to the primary key. Instead of including all values of the columns of the primary key, the index of the table in Clickhouse includes only the first row of each granule. The index is thus called a sparse index. FIG. 4B is a block diagram showing an example of the table level metadata. In this example, the table level metadata is the index of the table. The index of the table is recorded in the index file primary.idx 450 (e.g., the first metadata file), which includes the values of the primary key columns of the first row in each granule. As discussed above, the primary key columns in this example include the User-ID column and the URL column. The first granule is granule_0. The first row in the first granule (granule_0) is row_0. Therefore, the first index 452 includes the values of User_ID and URL of row_0 in granule_0. Similarly, the second index 454 includes the values of the User_ID and URL of row_8,192 in granule_1. The last index 456 includes the values of the User_ID and URL of row_8,863,744 in granule_1082. Each table has an index file to record the table indexes, e.g., the values of the primary key columns of the first row in each granule. The index file is metadata in table level.

At step 204, the computing system compresses the table data in a block unit and records column level metadata in a second metadata file. The column level metadata can be used to identify the position information of the first row of each granule in each block. The column level metadata include (i) the position information of each compressed block and (ii) the position information of the first row of each granule included in the decompressed block.

The table data are compressed in the unit of block. The block is the smallest unit of data read by Clickhouse. The size of each block can be configured by users using compress_block_size parameters. For example, the maximum compress_block_size can be 1,048,576 bytes. The minimum compress_block_size can be 65,535 bytes. Each block can include multiple granules.

In addition to the value of each granule, the position information of the first row of each granule is saved in a mark file (e.g., the second metadata file). This position information is saved as an array containing two values, the first value (block_offset) marks the position of the compression block corresponding to that granule in the column file. The second value (granule_offset) marks the position of the granule in the block after decompression.

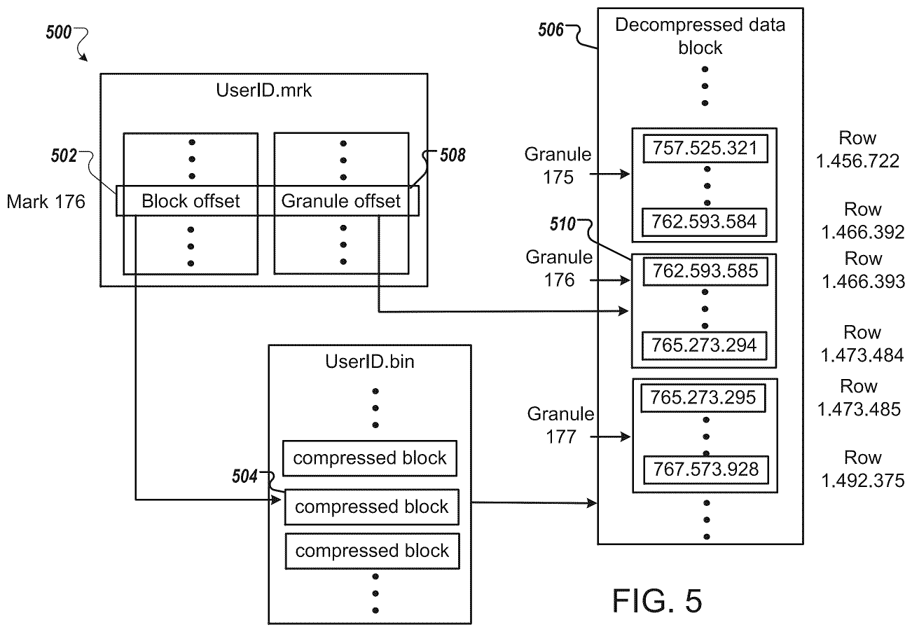

FIG. 5 is a block diagram showing an example of the mark file including position information of the first row of each granule. The block_offset value 502 in the mark file indicates the position of the compressed block in the column. Based on the block_offset value, the corresponding compressed block 504 can be retrieved. After retrieving, the compressed block 504 can be decompressed to obtain the decompressed block data 506. The granule_offset 508 in the mark file indicates the position of the first row of each granule included in the decompressed block. Based on the granule_offset 508, the first row of a particular granule can be located, which is the starting position of the granule. As a result, the whole granule can be located and retrieved. Each column has a mark file to record the position information of the granules and the blocks included in the column. The mark file is metadata in column level.

At step 206, the computing system, e.g., the KMS 102A, generates different data keys including a column key for each column and a block key for each block including sensitive information.

For the table data, the computing system encrypts data in the smallest compression unit, e.g., the compressed block in Clickhouse. Each column has a separate column key that is a data key used to encrypt the data included in that column. For example, the same data key is used for the same column. These data keys for columns are referred to as column keys.

Further, the computing system generates block keys for blocks having a higher security level. For example, the blocks having a higher security level are blocks including sensitive data, e.g., blocks having one or more cells that contain sensitive data. A cell is the cross of row and column. In some embodiments, information from a row descriptor is used to determine whether a row contains sensitive data. Specifically, the row descriptor includes a row value range that provides the value range of the rows in the page. For example, the row value range can be “UserID=[0, 100], which indicates that the block stores user IDs from 0-100. The KMS or other trusted service, e.g., a central configuration service, can check this row range information to determine whether there are any sensitive rows in the range. Each sensitive block has a separate block key that is a data key used to encrypt the sensitive block. The block keys are different from the column keys. In the following description, a federated writer and reader will be described that provides the ability to use a separate block key to encrypt each sensitive block.

In addition to the table data that includes values of one or more columns, there are metadata associated with the table data. The metadata include table level metadata, such as the index file shown in FIG. 4B; and column level metadata, such as the mark file for each column shown in FIG. 5.

For the table level metadata, the computing system generates a table key to encrypt the table level metadata, e.g., the index file.

For the column level data, the computing system uses the column key of the corresponding column to encrypt the column's metadata, e.g., the mark file.

To generate the data keys including the column keys, block keys, and table key, the computing system calls a key management system (KMS) with necessary data location information, such as database name, table name, column name, row descriptor, etc. The KMS generates the data keys, and saves a mapping relationship between the generated data key and the data location information.

By generating the column keys, block keys, and table key at KMS, the end users do not need to know which keys are used for which column. The system is fully transparent.

By using the same column key for the same column, the overhead of KMS interaction is minimized.

By using block keys to encrypt blocks with sensitive information, encryption in fine granularity is achieved, which allows for precise access control and the ability to perform cryptographic shredding.

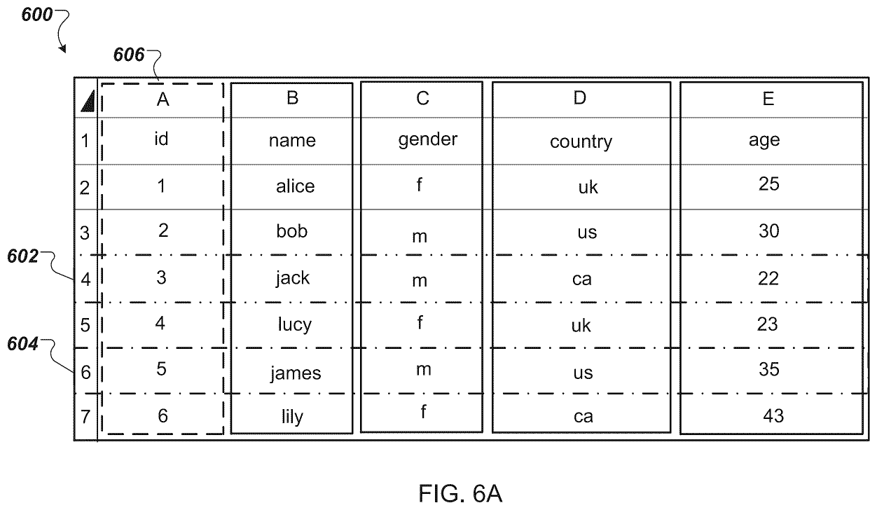

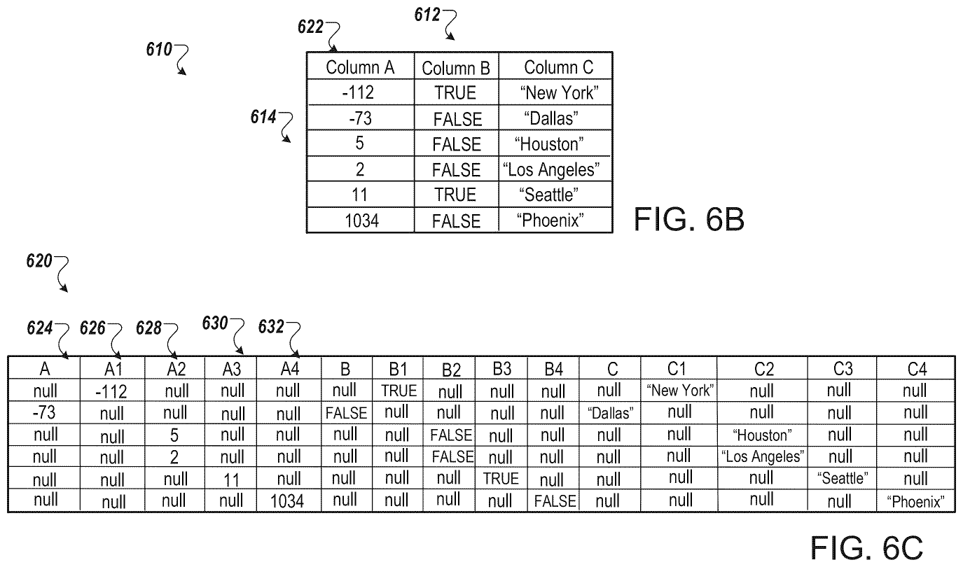

The system employs a schema-based permission model for precise access control. FIG. 6 and associated descriptions provide additional details of these implementations. The permission model enables granular encryption of the smallest data units within file formats and offers various encryption modes for flexibility.

The technologies centralize key management for easy access and auditing while maintaining stringent access control through the schema-based permission mode. The technologies ensure robust data security with minimal performance impact and seamless transparency for end-users.

Furthermore, the technologies minimize the overhead of querying data since only certain columns/blocks that contain the queried data need to be decrypted.

At step 208, the computing system, e.g., the data writer, encrypts each block including sensitive information with the corresponding block key and encrypts the rest of blocks in each column with the corresponding column key. The computing system encrypts the table's metadata with the table key and encrypts each column's metadata with the corresponding column key.

Specifically, if a column includes blocks with sensitive information, the computing system calls the KMS to encrypt the blocks with their corresponding block keys, and to encrypt the rest of data included in the column with the corresponding column key. If a column does not include blocks with sensitive information, the whole column is encrypted with the corresponding column key. In this modular key approach, fine-grained encryption of the smallest data units within the file formats is performed, which allows precise access control and offers various encryption modes for flexibility.

In particular, when writing data, a federated data writer will check the metadata to get the sensitive row ranges. Then the data writer expands the original data block into a block with two or more implicit columns. The system achieves granular encryption by splitting the original column into multiple implicit columns when writing data so that different encryption keys can be applied to different cells in the original column. Specifically, a given original column is separated into as many implicit columns as the number of sensitive row ranges for the original column of a table because the same sensitive row range will share the same encryption key as well as the access policy. That is to say, if there are n sensitive row ranges of a table, then there will be n implicit columns of each column. Different column keys are used to encrypt all the columns, including the implicit columns. Since different encryption keys map to different access policies, there needs to be n implicit or hidden columns of each column if there are n sensitive row ranges of a table.

The sensitive row ranges can be specified by the end user or an administrator. The sensitive row ranges can be changed over time and the file encryption will be updated accordingly when the background merge happens.

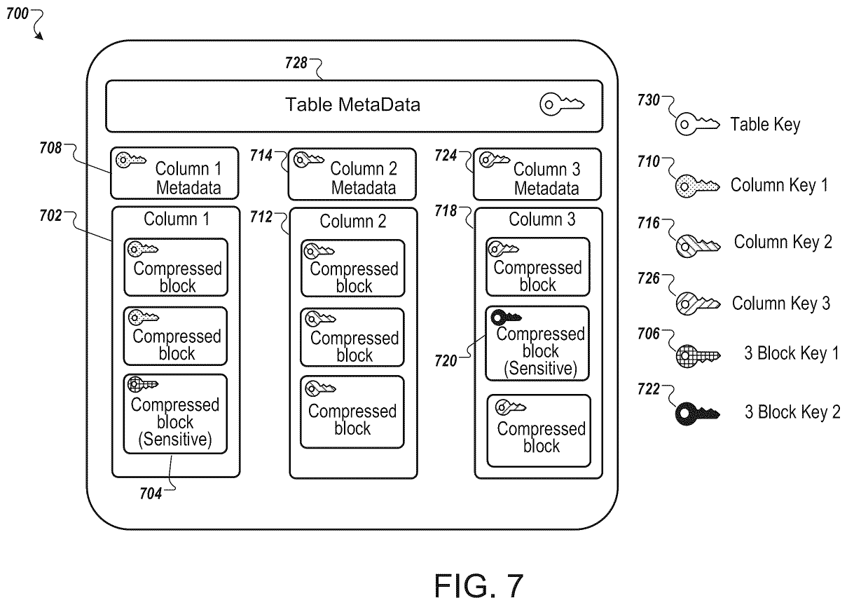

FIG. 7 is a block diagram showing an example of fine-grained encryption 700 in the table. The table includes three columns. Each column includes multiple compressed blocks. Some of the compressed blocks include sensitive data. Each column is associated with its column level metadata. The table is associated with table level metadata.

For example, the first column Column-1 702 includes multiple compressed blocks where one block 704 includes sensitive data. The sensitive block 704 is encrypted with Block Key 1 706. The rest of the blocks in Column-1 and the column level metadata 708 of Column-1 are encrypted with Column-Key-1 710.

The second column Column-2 712 does not include sensitive data. All the blocks and the metadata 714 of Column-2 are encrypted with the Column-Key-2 716.

The third column Column-3 718 includes one block 720 with sensitive information. The sensitive block 720 is encrypted with Block Key 2 722. The rest of the blocks in Column-3 and the metadata 724 of Column-3 are encrypted with Column-Key-3 726.

The table level metadata 728 is encrypted with the table key 730.

The security is enhanced through fine-grained encryption, using different data keys for different data modules of the Clickhouse file format. The modules include blocks, index files, mark files, or other data structures in Clickhouse.

At step 210, the computing system generates wrapped keys for the column keys, block keys, and table key. Specifically, as described above, the KMS wraps the data keys and provides the wrapped keys to the data writer, which then stores the wrapped keys in a separate client-side key file.

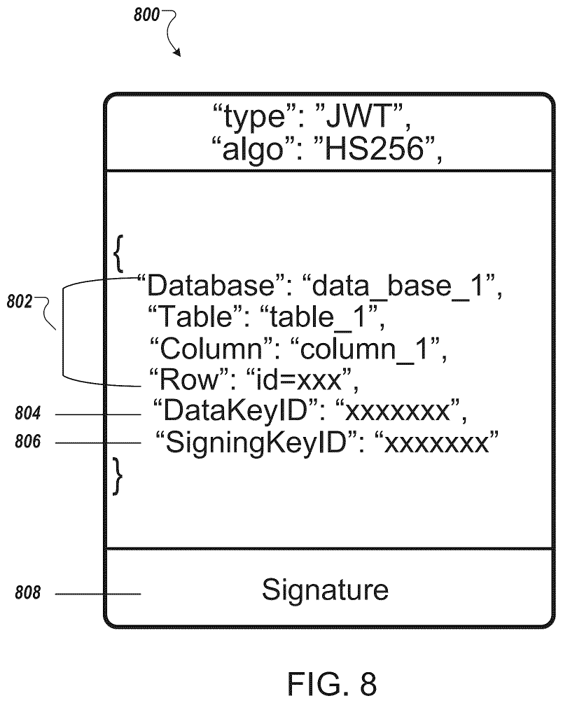

The computing system generates a wrapped key for each data key. The data keys include the column keys, block keys, and table key. Each wrapped key includes an identifier (ID) of a data key and location information of data that is encrypted using the data key. In other words, the data key identifier (ID) and the corresponding data location information are wrapped in an object called a wrapped key. The KMS signs the wrapped key using a private key, e.g., a wrapped key signing key, to generate a signature. The signature is attached to the wrapped key. FIG. 8 and associated descriptions provide additional details of wrapped keys.

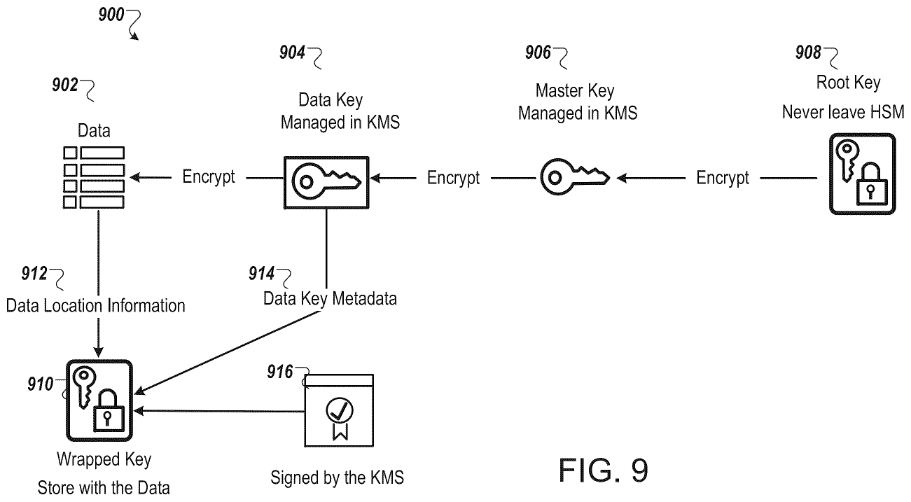

In some embodiments, the computing system uses envelope encryption according to a three layer key hierarchy that makes the solution scalable and maintainable, particularly for large enterprises. In this modular encryption different encryption mechanisms and storage media are used. For example, each data key is encrypted using a master key and each master key is encrypted using a root key. The encrypted data keys, the master keys, and the root keys are stored on the server side. In particular, the data keys are stored in a data key store, the master keys are stored in a master key store. The data key store and the master key store can be on the KMS. The root keys are stored in a root key store on the HSM. The wrapped keys are stored on the client side. key file, which may be associated with the untrusted or semi-trusted services, e.g., the data writer and data reader, rather than stored in the trusted KMS. Separating the data key store, master key store, and root key store can improve security and efficiency and provides a more granular control over storage and security of the different keys. In particular, each store can have different security levels that satisfy particular security standards that allow for some keys to be more securely stored than others, which reduces security costs. FIG. 9 and associated descriptions provide additional details of the envelope encryption. The wrapped key signing keys are also stored on the server side.

At step 212, the computing system stores the encrypted table data in one or more data files, e.g., data files 108. The encrypted column level metadata and the encrypted table level metadata can also be stored as part of the data file of the storage device. The wrapped keys are stored in key files in a separate key file folder.

The data files are stored in a folder path designated to the table. The key files including the wrapped keys are stored in a dedicated space in a shared file system which is owned and managed by a security team. People need permission to access the files in this dedicated space. As discussed above, the wrapped keys are in a shared file system on the client side.

At step 214, for each encryption unit in each data file, the computing system stores the reference to the corresponding key file in a header of the encryption unit of the data file.

The reference to the key file indicates the storage location of the key file. Based on the reference, a data reader can locate the key file. As discussed above, the key file includes the wrapped keys used to encrypt the data of the encryption unit. The encryption unit includes an encrypted block, the encrypted column level metadata, and the encrypted table level metadata. The wrapped keys hold information indicating what data keys are used to encrypt data from what location. After locating the key file, the data reader can further identify the data key ID for required data.

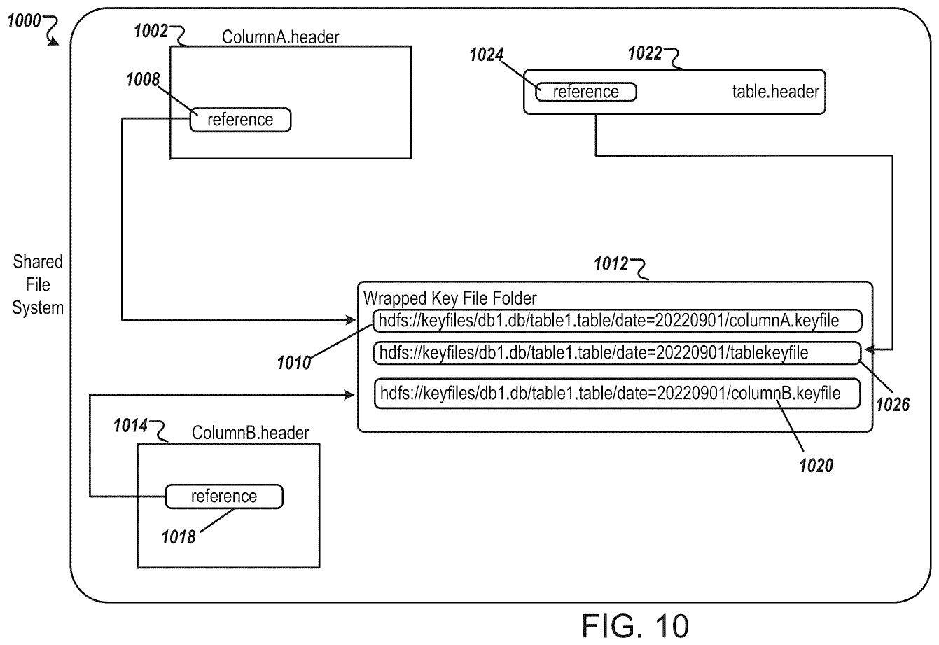

FIG. 10 is an example of data files generated in response to the writing request. The data files include the header of the encryption unit of each data file with reference to the corresponding key file. As shown in the figure, the first data file 1002 for Column A includes data of a compressed block that is encrypted with a data key. The compressed is an encryption unit in this example. A header, e.g., ColumnA.header, is inserted into this unit. The header includes a reference 1008 to the key file 1010 including the wrapped key of the data key used to encrypt the first compressed block of the fist data file for column A. The reference 1008 to the key file 1010 includes the location, such as a folder path, of the key file, where the key file is stored in a key file folder 1012 in a dedicated space in a shared file system.

Similarly, the storage device includes a second data file 1014 for Column B. Column B includes a compressed block that is encrypted using its corresponding data key. A header, e.g., ColumnB.header, is inserted into the compressed block. The header includes a reference 1018 to another key file 1020 storing the wrapped key for the corresponding data key.

Further, the storage device includes a data file 1022 for the table level metadata. The table level metadata is an encryption unit that is encrypted with the table key. A header is inserted into the data file 1022. The header includes a reference 1024 to the key file 1026 storing the wrapped key of the table key.

By including the wrapped keys in a separate key file and including the reference to the key file in the header of the encryption unit of the data file, the technologies can ensure data readability across various storage locations as long as the reference to the key file is intact. Data files can be copied and moved across different environments without losing the ability to access or decrypt them.

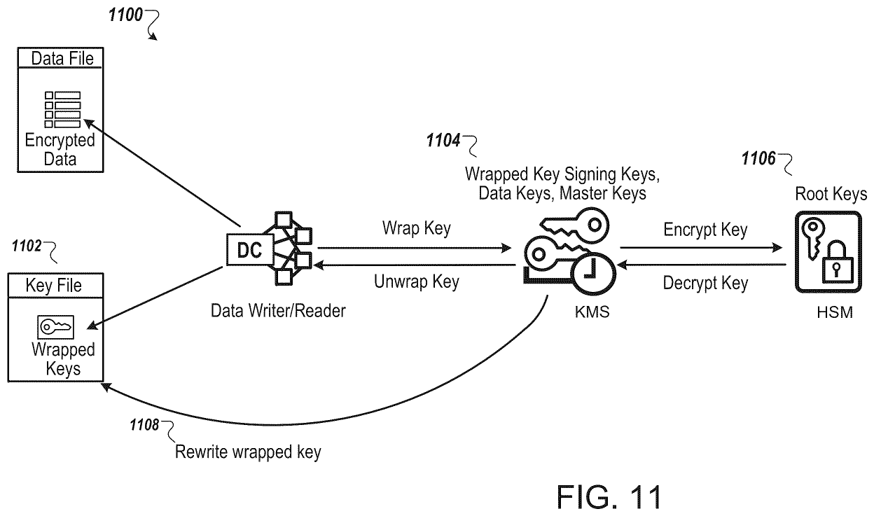

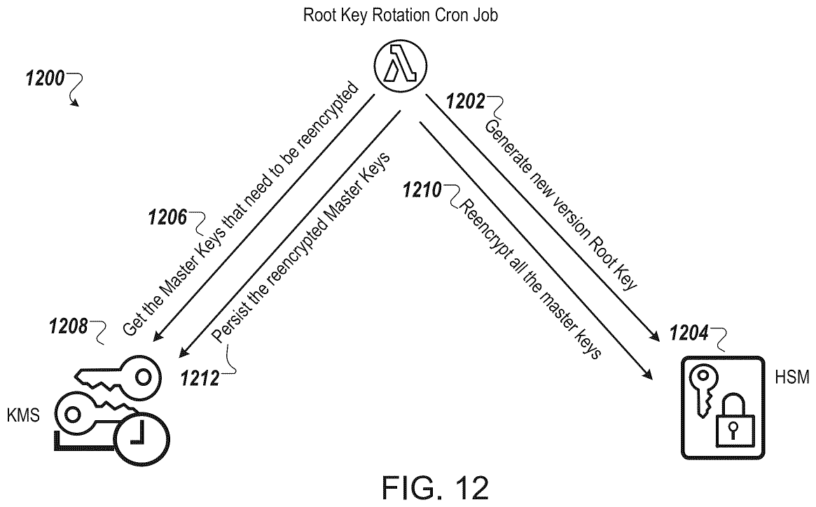

Furthermore, the centralization of key file storage allows for efficient server side secret rotation without the need to re-encrypt all data files, only the key files need to be updated. In particular, when rotating data keys, the data key ID or the data key version can be changed depending on how the data key file storage identifies the data keys, thus the key files are rewritten including the wrapped keys. Similarly, when rotating the wrapped key singing keys, e.g., in response to a possible leak, the wrapped keys are rewritten. FIGS. 11 and 12 and associated descriptions provide additional details of server-side secrets management and key rotation.

The order of steps in the process 200 described above is illustrative only, and the process 200 can be performed in different orders. In some implementations, the process 200 can include additional steps, fewer steps, or some of the steps can be divided into multiple steps.

FIG. 6A is a table example 600 with sensitive rows in a schema-based permission model.

The computing system employs the schema-based permission model for access control. This model divides the entire table into columns and sensitive rows. A user needs separate column privileges to read each column except the sensitive rows, and separate row privileges to read each sensitive row. For example, the permission model includes four hierarchies: “table privilege,” “table+row privilege,” “column privilege,” and “column+row privilege.”

The table example includes two sensitive rows 602, 604: a first row 602 whose ID=3 and a second row 604 whose ID=5.

A user with “table privilege” is able to read data of the entire table except the sensitive rows. Thus, in this example, the user with “table privilege” can read the data of the entire table 600 except the two sensitive rows 602, 604 whose IDs=3, 5, respectively.

A user with “table+row privilege” is able to read data of the entire table except sensitive rows of the table whose privileges are not assigned to the user. A user with table privilege and row privilege for row ID=3 (row 602) can read the data of the entire table except the sensitive row ID=5 (row 604).

A user with “column privilege” is able to read the data of the columns whose privileges are assigned to the user, except the sensitive rows. For example, a user with column privilege for column A 606 is able to read the data from column A, except data of the two sensitive rows 602, 604 included in column A 606. In other words, the user can read the values for rows with ID=1, 2, 4, 6, but cannot read the values in the rows with ID=3, 5.

A user with “column +row privilege” is able to read the data of the entire columns except sensitive rows of the columns whose privileges are not assigned to the user. For example, a user with privilege for column A 606 and row ID=3 (row 602) can read the entire column A except the sensitive row ID=5 (row 604).

By assigning specific permission based on table schema, the permission model enables fine-grained access control. Only authorized entities can access certain data segments, such as specific columns or sensitive rows within a table.

However, since data is stored in columns, the data of the same column can be split into different groups. It is necessary to encrypt sensitive row data with different keys according to different access policies. FIGS. 6B and 6C illustrate a process for using the federated writer to encrypt rows based on hidden columns.

FIG. 6B illustrates a table 610 with three columns 612, each having six rows 614. Different data in different rows 614 can have different access policies. For example, in FIG. 6B, Column A is Integer type, Column B is Boolean type and Column C is String type. A user can define, for example, A=[−1, 103], B=FALSE or C=“Phoenix” as sensitive rows. There can be four unique row policies:
Row 1 is a sensitive row in which Column B=TRUE.

Row 3 and 4 are sensitive rows in which Column A=5 and 2.

Row 5 is a sensitive row in which Column A=11 and Column B=TRUE. The access policy of row 5 is different from Rows 3 and 4.

Row 6 is a sensitive row in which Column C=“Phoenix”.

When writing such data, the federated writer expands the table with a number of hidden columns. All of the rows with the same access policy will be in the same hidden column. All of the columns can then be encrypted with respective column keys.

FIG. 6C illustrates a table 620, which is an expanded form of table 610 of FIG. 6B. In table 620, each column from table 610 is expanded with four hidden columns. For example, column A 622 of FIG. 6B is expanded into Column A 624 and hidden columns A1 626, A2 628, A3 630, and A4 632. In particular, each column only includes data corresponding to a particular access policy while the rest of the rows in that column are null. The number of columns can be managed by including rows with the same access policy in the same column. For example, hidden column A2 628 includes two cells of data from the original table because they have the same access policy.

The encryption keys are all separated at the column level. The hidden columns are not visible to end users, but instead will appear to be encrypted by the source column. In this way, from the end users'perspective, the sensitive cells and other cells are separated into different blocks and encrypted with different keys as shown in FIG. 7. When reading the data, the federated reader needs to get all the hidden columns from the metadata snapshot, read the data from all of the hidden columns and then merge the columns together. When reading data from all corresponding columns, the access policy authorization will be done when accessing the encryption keys. If the authorization fails, then the system will return empty for those rows. For example, in FIGS. 6B-C a user may have access to all regular rows and sensitive row A=−1, 103, but has no access to other sensitive rows. The merged result will return empty values for the rows in which the user does not have access.

FIG. 8 is an example of a wrapped key 800. Specifically, the data key identifier (ID) 804 and the corresponding data location information 802 are wrapped in an object called a wrapped key 800. The wrapped key is a data model to ensure the authenticity of the information passed from a data reader. The wrapped key is a token, e.g., a JWT token, where the payload holds information indicating what data keys are used to encrypt data from what location (database, table, column, row, etc.). The KMS signs the token with a private secret, e.g., a wrapped key signing key 806 to generate a signature 808. The wrapped key signing key 806 can be rotated.

FIG. 9 is a block diagram of an example envelope encryption model 900 incorporating a three-layer key hierarchy.

Specifically, the table data 902 are encrypted by data keys 904. The data keys are encrypted by master keys. One master key can be used to encrypt m data key. The data keys and the master keys are managed by the key management system (KMS). The encrypted data keys are stored in KMS.

As discussed above in FIG. 8, the wrapped keys 910 include the data location information 912, the data key metadata 914, such as the ID of the data key used to encrypt the data in corresponding to the data location information 912. The wrapped key 910 is further signed by the KMS 916 using the wrapped key signing key.

The wrapped keys are stored in a key file in a shared file system. The shared file system can use less expensive storage media, since usually the number of wrapped keys is huge.

The master keys are encrypted by root keys which are securely stored and managed within a hardware security module (HSM), ensuring the root keys never leave the secure environment. The HSM's sole responsibility is to protect the integrity of the root keys. One root key will be used to encrypt n master keys.

The values of m and n are based on the number of tables and total number of columns and the scalability of the KMS. For example, if there are 1 million tables and 100 columns in each table on average, and if m=100 and n=100, then there will be 1 million master keys and 100 thousand root keys that need to be managed centrally.

To recap, only the wrapped keys are stored on the client-side, i.e., in the key file 110. The data keys are stored in the KMS, e.g., in a data key store. The master keys are stored in the KMS, e.g., in a master key store, the wrapped key signing keys are stored in the KMS. The root keys are stored on the HSM.

FIG. 11 is a block diagram of an example process of secret management 1100. The wrapped keys are stored in a key file 1102 on the client side. The wrapped key signing keys, data keys, and master keys are stored at KMS 1104. The root keys are stored at HSM 1106. As discussed above, the wrapped keys are signed using the wrapped key signing keys. In some instances, the wrapped key is rewritten 1108. For example, when rotating secrets, e.g., data keys or wrapped key signing keys.

FIG. 12 is a block diagram of an example process of root key rotation 1200. The components of environment 100 of FIG. 1, appropriately programmed, can perform the process 1200 by calling the KMS and HSM.

As discussed above, the master keys are encrypted using the root keys. In 1202, a new root key 1202 is generated by HSM 1204. In 1206, the master keys are obtained from the KMS 1208. These master keys need to be re-encrypted using the new root keys. In 1210, the master keys are re-encrypted using the new root keys. In 1212, the re-encrypted master keys are persisted at KMS.

In master key rotation, a new version of master key is generated. The master key is rotated more frequently than the root key. For example, the root key is rotated 6 months to 1 year. After the new master key is generated, the data keys are re-encrypted using the new master key.

In data key rotation, a new version of the data key is generated. The data keys are usually not rotated regularly. For example, the data key rotation is triggered on demand, when a security risk is detected, e.g., the data key is leaked. In some embodiments, when the KMS receives an unwrap key request of any outdated data key, the data key rotation is triggered and the corresponding data file is rewritten.

In rotation of the wrapped key signing keys, the KMS generates a new version of the wrapped key signing key when the particular wrapped key signing key has been used x times. The value of x can be set according to a user's demand on security level, the scale of data files, and other factors. In some embodiments, when the KMS receives a notification of an outdated wrapped key signing key, the rotation of the wrapped key signing keys is triggered and the corresponding wrapped key is re-signed.

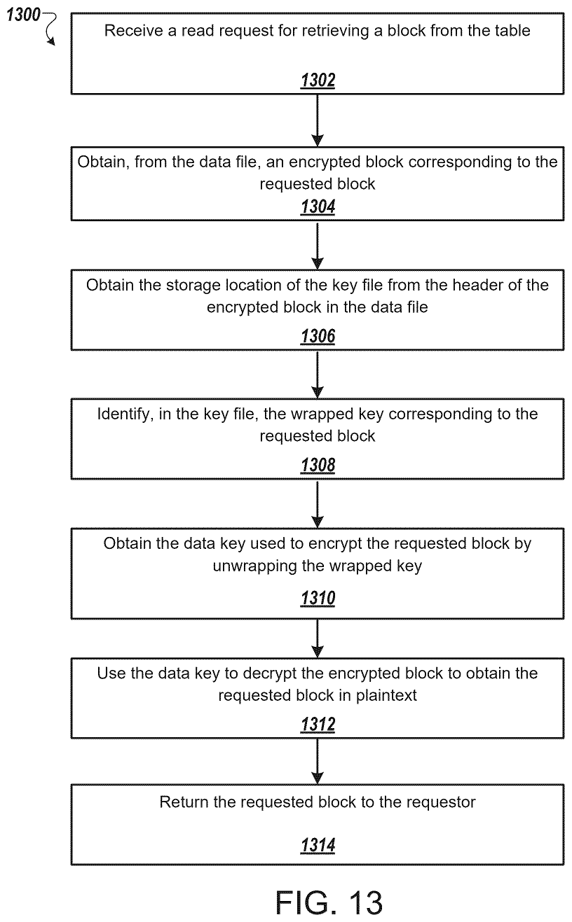

FIG. 13 is a flow diagram of an example process 1300 for reading table data in file-format based transparent encryption. For convenience, the process 1300 will be described as being performed by a system of one or more computers, located in one or more locations, and programmed appropriately in accordance with this specification. For example, a computing system, e.g., the data reader 106 of FIG. 1, appropriately programmed, can perform the process 1300.

At step 1302, the computing system receives, from a requestor, a read request for retrieving a block from the table.

The read request includes the information identifying the requested block, such as the database ID, table ID, column, block, row, etc.

At step 1304, the computing system obtains, from the data file, an encrypted block corresponding to the requested block.

The blocks of the table data are encrypted and stored in the data file. Based on the information of the read request. Using the example in FIG. 10, the computing system can obtain the encrypted block 1004 from the data file 1002.

To decrypt the encrypted table data, the computing system needs to obtain the data key used to encrypt the requested block. The ID of the data keys used to encrypt the table data are included in the wrapped keys in the key file. The computing system therefore needs to access the key file to obtain the data key. As discussed above, the file header includes the reference to the corresponding key file of the table which refers to the location of the key file.

At step 1306, the computing system obtains the storage location of the key file from the header of the encrypted block in the data file.

Based on the location of the key file, the computing system can access the key file. The key file includes the wrapped keys with metadata of the data keys used to encrypt the table data. Using the example in FIG. 10, assuming the requested block is Block 1 1004, the computing system can obtain the storage location of the key file 1010 from the header 1006 that includes the reference 1008 to the key file 1010.

At step 1308, the computing system can identify, in the key file, the wrapped key corresponding to the requested block.

As discussed above, the wrapped key is a token where the payload holds information indicating what data keys are used to encrypt data from what location (database, table, column, row, etc.). The computing system can identify the wrapped key corresponding to the requested block.

At step 1310, the computing system obtains the data key used to encrypt the requested block by unwrapping the wrapped key.

The computing system calls the KMS to obtain the data key. The computing system can send an unwrap key request including the identified wrapped key to the KMS. The identified wrapped key includes the ID of the data key that is used to encrypt the requested block. As discussed above, a signature is attached to the wrapped key. The signature was generated by the KMS using a wrapped key signing key. The KMS can verify the integrity of the identified wrapped key based on the signature. Specifically, the KMS identifies the corresponding wrapped key signing key based on information in the key metadata and verifies the signature using the wrapped key signing key and the information included in the wrapped key.

As discussed above, each data key is encrypted with a master key and stored at KMS. In an unwrapping process, the KMS identifies the encrypted data key based on the ID of the data key, and decrypts the encrypted data key using the master key. As a result, the KMS can obtain the plaintext of the data key used to encrypt the requested block. The KMS transmits the plaintext data key to the data reader of the computing system. Even though the KMS is trusted, to maintain security the keys are encrypted for storage at the KMS.

At step 1312, the computing system uses the data keys to decrypt the encrypted block to obtain the requested block in plaintext. Specifically, the computing system uses the federated reader to read the hidden columns for the table and merges the hidden columns together. When reading the hidden columns, access policy authorization can be performed to determine whether the requestor has access to each sensitive row.

At step 1314, the computing system returns the requested block to the requestor including all regular rows and any sensitive rows the requestor has permission to access. The requested block can be further decompressed.

In some embodiments, in the process of obtaining the encrypted block or certain granules in the requested block, the computing system may need to obtain metadata first, including the table level metadata (index file shown in FIG. 4B) and the column level metadata (the mark file for each column shown in FIG. 5). As discussed above, the table level metadata includes the indexes of the table. The column level metadata includes the block_offset that marks the position of each compression block and the granule_offset that marks the position of the granule in the block after decompression. With such metadata, the computing system can locate the position of the requested block in the storage device.

Because the metadata files are also encrypted, the computing system needs to obtain the keys used to encrypt the metadata and use these keys to decrypt the encrypted metadata. Therefore, the computing system needs to perform steps similar to steps 1306-1314 on the data files of the metadata. For example, to obtain the plaintext table level metadata, the computing system can use the header in the data file for the table level metadata (such as the data file 1022 in FIG. 10) to obtain the location of the key file (such as the key file 1026 in FOG. 10) including the wrapped key of the table key. Using the ID of the table key, the computing system can obtain the table key and further use the table key to decrypt the encrypted table level metadata. Similarly, to obtain the plaintext column level metadata, the computing system can use the header in the data file for the column level metadata (such as the data file 1028 in FIG. 10) to obtain the location of the key file (such as the key file 1026 in FIG. 10) including the wrapped key of the column key. Using the ID of the column key, the computing system can obtain the column key and further use the column key to decrypt the encrypted column level metadata. After obtaining the plaintext table level metadata and the plaintext column level metadata, the computing system can locate the position of the requested block and/or certain granules in the requested block using at least the block_offset and/or the granule_offset included in the metadata.

The order of steps in the process 1300 described above is illustrative only, and the process 1300 can be performed in different orders. In some implementations, the process 1300 can include additional steps, fewer steps, or some of the steps can be divided into multiple steps.

Embodiments of the subject matter and the actions and operations described in this specification can be implemented in digital electronic circuitry, in tangibly-embodied computer software or firmware, in computer hardware, including the structures described in this specification and their structural equivalents, or in combinations of one or more of them. Embodiments of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively or in addition, the carrier may be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed on a system of one or more computers in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

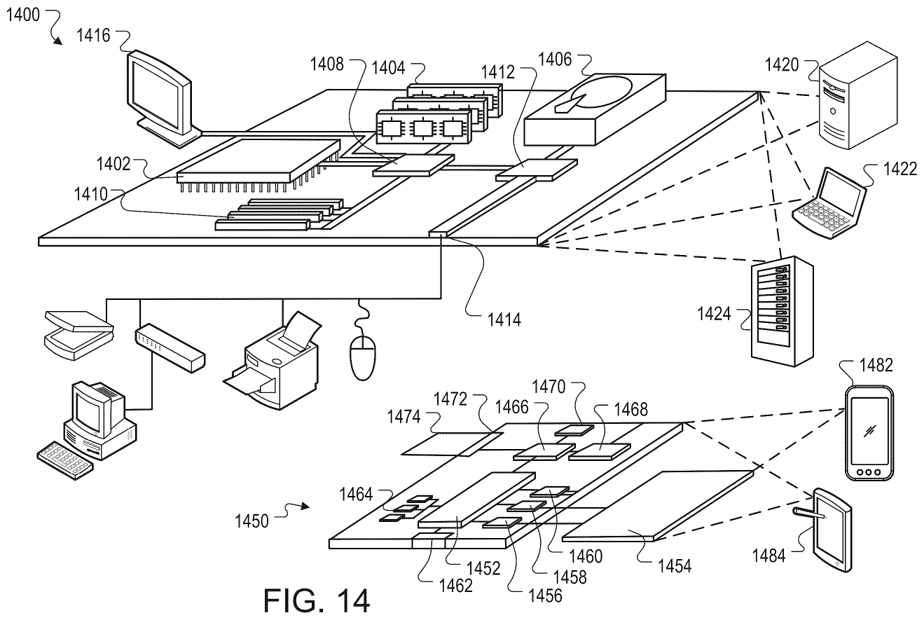

FIG. 14 shows an example of a computing device 1400 and a mobile computing device 550 (also referred to herein as a wireless device) that are employed to execute implementations of the present description. The computing device 1400 is intended to represent various forms of digital computers, such as laptops, desktops, workstations, personal digital assistants, servers, blade servers, mainframes, and other appropriate computers. The mobile computing device 1450 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 1400 can form at least a portion of the computing system 102.

The computing device 1400 includes a processor 1402, a memory 1404, a storage device 1406, a high-speed interface 1408, and a low-speed interface 1412. In some implementations, the high-speed interface 1408 connects to the memory 1404 and multiple high-speed expansion ports 1410. In some implementations, the low-speed interface 1412 connects to a low-speed expansion port 1414 and the storage device 1406. Each of the processor 1402, the memory 1404, the storage device 1406, the high-speed interface 1408, the high-speed expansion ports 1410, and the low-speed interface 1412, are interconnected using various buses, and may be mounted on a common motherboard or in other manners as appropriate. The processor 1402 can process instructions for execution within the computing device 1400, including instructions stored in the memory 1404 and/or on the storage device 1406 to display graphical information for a graphical user interface (GUI) on an external input/output device, such as a display 1416 coupled to the high-speed interface 1408. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 1404 stores information within the computing device 1400. In some implementations, the memory 1404 is a volatile memory unit or units. In some implementations, the memory 1404 is a non-volatile memory unit or units. The memory 1404 may also be another form of a computer-readable medium, such as a magnetic or optical disk.

The storage device 1406 is capable of providing mass storage for the computing device 1400. In some implementations, the storage device 1406 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 1402, perform one or more methods, such as those described above. The instructions can also be stored by one or more storage devices, such as computer-readable or machine-readable mediums, such as the memory 1404, the storage device 1406, or memory on the processor 1402.

The high-speed interface 1408 manages bandwidth-intensive operations for the computing device 1400, while the low-speed interface 1412 manages lower bandwidth-intensive operations. Such allocation of functions is an example only. In some implementations, the high-speed interface 1408 is coupled to the memory 1404, the display 1416 (e.g., through a graphics processor or accelerator), and to the high-speed expansion ports 1410, which may accept various expansion cards. In the implementation, the low-speed interface 1412 is coupled to the storage device 1406 and the low-speed expansion port 1414. The low-speed expansion port 1414, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 1414 through a network adapter. Such network input/output devices may include, for example, a switch or router.

The computing device 1400 may be implemented in a number of different forms, as shown in the FIG. 14. For example, it may be implemented as a standard server 1420, or multiple times in a group of such servers. In addition, it may be implemented in a personal computer such as a laptop computer 1422. It may also be implemented as part of a rack server system 1424. Alternatively, components from the computing device 1400 may be combined with other components in a mobile device, such as a mobile computing device 1450. Each of such devices may contain one or more of the computing device 1400 and the mobile computing device 1450, and an entire system may be made up of multiple computing devices communicating with each other.

The mobile computing device 1450 includes a processor 1452; a memory 1464; an input/output device, such as a display 1454; a communication interface 1466; and a transceiver 1468; among other components. The mobile computing device 1450 may also be provided with a storage device, such as a micro-drive or other device, to provide additional storage. Each of the processor 1452, the memory 1464, the display 1454, the communication interface 1466, and the transceiver 1468, are interconnected using various buses, and several of the components may be mounted on a common motherboard or in other manners as appropriate. In some implementations, the mobile computing device 1450 may include a camera device(s) (not shown).

The processor 1452 can execute instructions within the mobile computing device 1450, including instructions stored in the memory 1464. The processor 1452 may be implemented as a chipset of chips that include separate and multiple analog and digital processors. For example, the processor 1452 may be a Complex Instruction Set Computers (CISC) processor, a Reduced Instruction Set Computer (RISC) processor, or a Minimal Instruction Set Computer (MISC) processor. The processor 1452 may provide, for example, for coordination of the other components of the mobile computing device 1450, such as control of user interfaces (UIs), applications run by the mobile computing device 1450, and/or wireless communication by the mobile computing device 1450.

The processor 1452 may communicate with a user through a control interface 1458 and a display interface 1456 coupled to the display 1454. The display 1454 may be, for example, a Thin-Film-Transistor Liquid Crystal Display (TFT) display, an Organic Light Emitting Diode (OLED) display, or other appropriate display technology. The display interface 1456 may include appropriate circuitry for driving the display 1454 to present graphical and other information to a user. The control interface 1458 may receive commands from a user and convert them for submission to the processor 1452. In addition, an external interface 1462 may provide communication with the processor 1452, so as to enable near area communication of the mobile computing device 1450 with other devices. The external interface 1462 may provide, for example, for wired communication in some implementations, or for wireless communication in other implementations, and multiple interfaces may also be used.

The memory 1464 stores information within the mobile computing device 1450. The memory 1464 can be implemented as one or more of a computer-readable medium or media, a volatile memory unit or units, or a non-volatile memory unit or units. An expansion memory 1474 may also be provided and connected to the mobile computing device 1450 through an expansion interface 1472, which may include, for example, a Single in Line Memory Module (SIMM) card interface. The expansion memory 1474 may provide extra storage space for the mobile computing device 1450, or may also store applications or other information for the mobile computing device 1450. Specifically, the expansion memory 1474 may include instructions to carry out or supplement the processes described above, and may include secure information also. Thus, for example, the expansion memory 1474 may be provided as a security module for the mobile computing device 1450, and may be programmed with instructions that permit secure use of the mobile computing device 1450. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 1452, perform one or more methods, such as those described above. The instructions can also be stored by one or more storage devices, such as one or more computer-readable or machine-readable mediums, such as the memory 1464, the expansion memory 1474, or memory on the processor 1452. In some implementations, the instructions can be received in a propagated signal, such as, over the transceiver 1468 or the external interface 1462.

The mobile computing device 1450 may communicate wirelessly through the communication interface 1466, which may include digital signal processing circuitry where necessary. The communication interface 1466 may provide for communications under various modes or protocols, such as Global System for Mobile Communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 568 using a radio frequency. In addition, short-range communication, such as using Bluetooth or Wi-Fi, may occur. In addition, a Global Positioning System (GPS) receiver module 570 may provide additional navigation—and location—related wireless data to the mobile computing device 1450, which may be used as appropriate by applications running on the mobile computing device 1450.

The mobile computing device 1450 may also communicate audibly using an audio codec 1460, which may receive spoken information from a user and convert it to usable digital information. The audio codec 1460 may likewise generate audible sound for a user, such as through a speaker, e.g., in a handset of the mobile computing device 1450. Such sound may include sound from voice telephone calls, may include recorded sound (e.g., voice messages, music files, etc.) and may also include sound generated by applications operating on the mobile computing device 1450.

The mobile computing device 1450 may be implemented in a number of different forms, as shown in FIG. 14. Other implementations may include a phone device 1482 and a tablet device 1484. The mobile computing device 1450 may also be implemented as a component of a smart-phone, personal digital assistant, AR device, or other similar mobile device.

Although a few implementations have been described in detail above, other modifications may be made without departing from the scope of the inventive concepts described herein, and, accordingly, other implementations are within the scope of the following claims.

1. A computer-implemented method comprising:
receiving, by one or more computing devices, a write request including a table with one or more columns to be stored in a storage device;
compressing table data in a unit of block, wherein each column includes a number of blocks;
generating a column key for each column and a block key for each block including sensitive information;
encrypting (i) each block including sensitive information with a corresponding block key and (ii) rest of blocks in each column with a corresponding column key;
generating wrapped keys for the column keys and block keys and storing the wrapped keys into a key file;
storing the encrypted blocks of each column into a data file in a data folder of the storage device and storing the wrapped keys in a key file in a separate key file folder; and
storing a reference to the key file in a header of each encrypted block in the data file.

2. The computer-implemented method of claim 1, wherein the key file is in a dedicated space in a shared file system that requires permission to access.

3. The computer-implemented method of claim 1, wherein each wrapped key includes an identifier of a data key and location information of data that is encrypted using the data key.

4. The computer-implemented method of claim 3, wherein the wrapped key is signed using a wrapped key signing key.

5. The computer-implemented method of claim 1, wherein the reference indicates a storage location of the key file.

6. The computer-implemented method of claim 1, wherein each data key, included in the column keys and the block keys, is encrypted using a master key, and the master key is encrypted using a root key.

7. The computer-implemented method of claim 1, further comprising:
receiving, from a requestor, a read request for retrieving a block from the table;
obtaining, from the data file, an encrypted block corresponding to the requested block;
obtaining a storage location of the key file from the header of the encrypted block in the data file;
identifying, in the key file, the wrapped key corresponding to the requested block;
obtaining a data key used to encrypt the requested block by unwrapping the wrapped key;
using the data key to decrypt the encrypted block to obtain the requested block in plaintext; and
returning the requested block to the requestor.

8. The computer-implemented method of claim 1, wherein:
the table is divided into columns and sensitive rows,
separate column privileges are required to read each column except the sensitive rows and separate row privileges are required to read each sensitive row,
a permission model to access table data comprises four hierarchies: “table privilege,” “table+row privilege,” “column privilege,” and “column+row privilege.”

9. The computer-implemented method of claim 1, further comprising:
recording table level metadata;
recoding column level metadata;
encrypting the table level metadata with a table key;
encrypting the column level metadata with the column key;
storing the encrypted table level metadata into a second data file;
storing the encrypted column metadata into a third data file;
generating a wrapped key for the table key;
storing the wrapped key for the table key into another key file in the key file folder;
storing, in a header of second data file, a reference to the another key file including the wrapped key for the table key; and
storing, in a header of the third data file, a reference to the key file including the wrapped key for the column key.

10. The computer-implemented method of claim 9, wherein:
the table level metadata includes table indexes, and
the column level metadata includes (i) position information of each compressed block and (ii) position information of a first row of each granule included in a decompressed block, wherein each granule includes a predetermined number of rows of the table.

11. The computer-implemented method of claim 1, wherein encrypting each block further comprises:
expanding the block to include a plurality of hidden columns, wherein a number of hidden columns corresponding to a number of sensitive row ranges for each original column of the block; and
encrypting each column and hidden column with a respective column key.

12. A system comprising one or more computers and one or more storage devices on which are stored instructions that are operable, when executed by the one or more computers, to cause the one or more computers to perform operations comprising:
receiving, by one or more computing devices, a write request including a table with one or more columns to be stored in a storage device;
compressing table data in a unit of block, wherein each column includes a number of blocks;
generating a column key for each column and a block key for each block including sensitive information;
encrypting (i) each block including sensitive information with a corresponding block key and (ii) rest of blocks in each column with a corresponding column key;
generating wrapped keys for the column keys and block keys and storing the wrapped keys into a key file;
storing the encrypted blocks of each column into a data file in a data folder of the storage device and storing the wrapped keys in a key file in a separate key file folder; and
storing a reference to the key file in a header of each encrypted block in the data file.

13. The system of claim 12, wherein the key file is in a dedicated space in a shared file system that requires permission to access.

14. The system of claim 12, wherein each wrapped key includes an identifier of a data key and location information of data that is encrypted using the data key.

15. The system of claim 14, wherein the wrapped key is signed using a wrapped key signing key.

16. The system of claim 12, wherein the reference indicates a storage location of the key file.

17. The system of claim 12, wherein each data key, included in the column keys and the block keys, is encrypted using a master key, and the master key is encrypted using a root key.

18. The system of claim 12, the operations further comprising:
receiving, from a requestor, a read request for retrieving a block from the table;
obtaining, from the data file, an encrypted block corresponding to the requested block;
obtaining a storage location of the key file from the header of the encrypted block in the data file;
identifying, in the key file, the wrapped key corresponding to the requested block;
obtaining a data key used to encrypt the requested block by unwrapping the wrapped key;
using the data key to decrypt the encrypted block to obtain the requested block in plaintext; and
returning the requested block to the requestor.

19. The system of claim 12, wherein:
the table is divided into columns and sensitive rows,
separate column privileges are required to read each column except the sensitive rows and separate row privileges are required to read each sensitive row,
a permission model to access table data comprises four hierarchies: “table privilege,” “table+row privilege,” “column privilege,” and “column+row privilege.”

20. A non-transitory computer-readable medium encoded with instructions that, when executed by one or more computers, cause the one or more computers to perform operations comprising:
receiving, by one or more computing devices, a write request including a table with one or more columns to be stored in a storage device;
compressing table data in a unit of block, wherein each column includes a number of blocks;
generating a column key for each column and a block key for each block including sensitive information;
encrypting (i) each block including sensitive information with a corresponding block key and (ii) rest of blocks in each column with a corresponding column key;
generating wrapped keys for the column keys and block keys and storing the wrapped keys into a key file;
storing the encrypted blocks of each column into a data file in a data folder of the storage device and storing the wrapped keys in a key file in a separate key file folder; and
storing a reference to the key file in a header of each encrypted block in the data file.
